(19) United States
(12) Patent Application Publication
(10) Pub. No.: US 2021/0233280 A1
(43) Pub. Date: Jul. 29, 2021

(54) ENCODING DEVICE CONTROL METHOD AND DEVICE, AND STORAGE MEDIUM

(71) Applicant: SZ DJI TECHNOLOGY CO., LTD., Shenzhen (CN)

(72) Inventors: Weiran LI, Shenzhen (CN); Xiaozhen ZHENG, Shenzhen (CN)

(21) Appl. No.: 17/211,433

(22) Filed: Mar. 24, 2021

Related U.S. Application Data
(63) Continuation of application No. PCT/CN2018/109062, filed on Sep. 30, 2018.

(51) Int. Cl. G06T 9/00; G06T 3/40; H04N 19/105; H04N 19/139; H04N 19/423; H04N 19/176

(52) U.S. Cl. CPC G06T 9/00; G06T 3/40; H04N 19/176; H04N 19/139; H04N 19/423; H04N 19/105

(57) ABSTRACT

The present disclosure provides a method for controlling an encoding device. The method includes determining a search area in a reference image of a current image block to be encoded, the reference image in the searching area being a search image, the reference image being stored in an external memory; obtaining image units that are not cached in N target image blocks from the external memory in sequence, the target image block being the search image in a target area in the search area, N being an integer greater than or equal to two, the first M target image blocks of the N target image blocks constituting a rectangular image, M being any integer less than or equal to N; storing the obtained image units in a cache, the N target image blocks stored in the cache being used for a motion search of the current image block to be encoded.

### CROSS-REFERENCE TO RELATED APPLICATIONS

This application is a continuation of International Application No. PCT/CN2018/109062, filed on Sep. 30, 2018, the entire content of which is incorporated herein by reference.

### TECHNICAL FIELD

The present disclosure relates to the technical field of image processing technology and, more specifically, to an encoding device control method and device, and a storage medium.

### BACKGROUND

A mobile robot (such as an unmanned aerial vehicle (UAV)) can be equipped with an imaging device. The image device can capture images in real time. The image information is encoded by an encoding device inside the mobile robot, and the encoded image is sent to the corresponding control terminal of the mobile robot.

The encoding device needs to encode each image block of the image when encoding the image. When encoding an image block, a reference image stored in an external image needs to be used to encode the image. Specifically, before encoding the image block, a search image of the image block needs to be determined in the reference image stored in the external device. The image units in the search image that are not stored in the cache needs to be obtained from the external memory, and the image units are stored in the cache. After the storage is completed, a motion search is performed using the search image stored in the cache.

In some cases, due to the bandwidth limitations, all image units in the search image that are not stored in the cache cannot be obtained from the external memory and stored in the cache. Often, under the bandwidth limitations, as many image units in the search image that are not stored in the cache are obtained from the external memory and stored in the cache as much as possible. However, using this method, after the storage is completed, the image stored in the cache may not be a rectangular image, such that only a rectangular image with the largest area can be selected for the motion search, which reduces the bandwidth resource utilization rate and coding efficiency.

### SUMMARY

One aspect of the present disclosure provides a method for controlling an encoding device. The method includes determining a search area in a reference image of a current image block to be encoded, the reference image in the searching area being a search image, the reference image being stored in an external memory; obtaining image units that are not cached in N target image blocks from the external memory in sequence, the target image block being the search image in a target area in the search area, N being an integer greater than or equal to two, the first M target image blocks of the N target image blocks constituting a rectangular image, M being any integer less than or equal to N; and storing the obtained image units in a cache, the N target image blocks stored in the cache being used for a motion search of the current image block to be encoded.

Another aspect of the present disclosure provides a device for controlling an encoding device. The device includes a processor; and a memory storing instructions that, when executed by the processor, cause the processor to: determine a search area in a reference image of a current n image block to be encoded, the reference image in the searching area being a search image, the reference image being stored in an external memory; obtain image units that are not cached in N target image blocks from the external memory in sequence, the target image block being the search image in a target area in the search area, N being an integer greater than or equal to two, the first M target image blocks of the N target image blocks constituting a rectangular image, M being any integer less than or equal to N; and store the obtained image units in a cache, the N target image blocks stored in the cache being used for a motion search of the current image block to be encoded.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic diagram of video data according to an embodiment of the present disclosure.

FIG. 2 is a schematic diagram of dividing an image frame into a plurality of image blocks to be encoded according to an embodiment of the present disclosure.

FIG. 3 is a schematic diagram of an arithmetic search according to an embodiment of the present disclosure.

FIG. 4 is a schematic diagram of a search area according to an embodiment of the present disclosure.

FIG. 5 is a schematic diagram of an image frame according to an embodiment of the present disclosure.

FIG. 6 is a schematic diagram of obtaining a largest rectangular area according to an embodiment of the present disclosure.

FIG. 7 is a flowchart of an encoding device control method according to an embodiment of the present disclosure.

FIG. 8 is a schematic diagram of dividing a search area according to an embodiment of the present disclosure.

FIG. 9 a schematic diagram of a target image block according to an embodiment of the present disclosure.

FIG. 10 is a schematic diagram of another target image block according to an embodiment of the present disclosure.

FIG. 11 is a flowchart of the encoding device control method according to another embodiment of the present disclosure.

FIG. 12 is a schematic diagram of a method for obtaining the target image block according to an embodiment of the present disclosure.

FIG. 13 a schematic diagram of the target image block according to another embodiment of the present disclosure.

FIG. 14 is a schematic diagram of a method for obtaining the target image block according to another embodiment of the present disclosure.

FIG. 15 is a structural schematic diagram of an encoding device control device according to an embodiment of the present disclosure.

### REFERENCE NUMERALS

10 Video data
11 Image frame
12 Image frame
121 Image block to be encoded
122 Image block to be encoded
123 Image block to be encoded
124 Image block to be encoded
111 Image block
21 Image block
22 Image block
23 Image block
24 Image block to be encoded
41 Area
42 Search area
43 Search area
51 Search area
52 Search area
61 Area
62 Partial area
63 Rectangular area
81 Reference image
82 Image to be encoded
83 Image to be encoded
84 Corresponding image block
85 Search area
86 Image unit
1 Target area
2 Target area
3 Target area
4 Target area
5 Target area
6 Target area
7 Target area
100 Search area
120 Corresponding image block
150 Control device
151 Memory
152 Processor

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure. It should be noted that technical solutions provided in the present disclosure do not require all combinations of the features described in the embodiments of the present disclosure.

It should be noted that, when one component is referred to as “fixed to” another component, it may be directly on another component or it is also possible that there is a third component between them. When one component is considered to “connect” another component, it may be directly connected to the other component or it is possible that there is a third component between them. When one component is considered to be “disposed on” another component, it may be directly disposed on the other component or it is possible that there is a third component between them.

Unless otherwise defined, all the technical and scientific terms used in the present disclosure have the same or similar meanings as generally understood by one of ordinary skill in the art. As described in the present disclosure, the terms used in the specification of the present disclosure are intended to describe example embodiments, instead of limiting the present disclosure. The term “and/or” as used herein includes any and all combinations of one or more related listed items.

Exemplary embodiments will be described with reference to the accompanying drawings. In the case where there is no conflict between the exemplary embodiments, the features of the following embodiments and examples may be combined with each other.

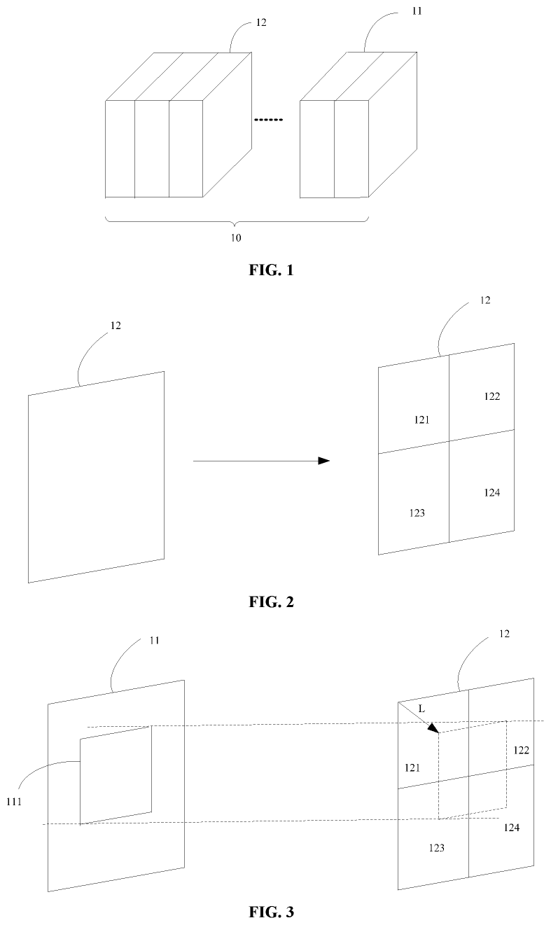

FIG. 1 is a schematic diagram of video data according to an embodiment of the present disclosure. As shown in FIG. 1, video data 10 include a plurality of frames of images, and image frame 11 and image frame 12 are any two frames of the plurality of frames of images. Generally, in order to reduce the bandwidth occupied by video data storage and transmission, video data needs to be encoded and compressed. Take image frame 12 as an example, when encoding the image frame 12, the image frame 12 can be divided into several image blocks to be encoded. As shown in FIG. 2, the image frame 12 is divided into four image blocks to be encoded, such as an image block to be encoded 121, an image block to be encoded 122, an image block to be encoded 123, and an image block to be encoded 124. For each image block to be encoded, an image block that best matches the image block to be encoded can be searched in a reference image corresponding to image frame 12 as a prediction block. For example, the reference image corresponding to image frame 12 may be image frame 11. The description provided here is merely an example, and the reference image corresponding to image frame 12 is not limited. Take the image block to be encoded 121 as an example, the image block that best matches the image block to be encoded 121 can be searched in the image frame 11 as the prediction block. As shown in FIG. 3, assume that an image block 111 in the image frame 11 best matches the image block to be encoded 121. The difference between the corresponding pixel values of the image block 111 and the image block to be encoded 121 can be calculated, and a motion vector L of the image block to be encoded 121 relative to the image block 111 can be calculated. Similarly, the image blocks that best matches the image block to be encoded 122, the image block to be encoded 123, and the image block to be encoded 124 can be respectively searched as the prediction block in the image frame 11, and the motion vectors of the image block to be encoded 122, the image block to be encoded 123, and the image block to be encoded 124 relative to the respective prediction blocks can be respectively determined. Finally, the image block to be encoded 121, the image block to be encoded 122, the image block to be encoded 123, and the image block to be encoded 124 can be respectively combined with the differences of the corresponding pixel values of the respective prediction blocks to obtain the residual of the image frame 12. An encoding device can encode the residual of the image frame 12, encode the motion vector corresponding to each image block to be encoded, and store or send the encoded residual and motion vector to a decoder. After receiving the encoded residual and motion vector, the decoder can first decode the residual of the image frame 12 and the motion vector corresponding to each image block to be encoded in the image frame 12. Next, the decoder can determine the prediction block corresponding to each image block to be encoded based on the motion vector corresponding to each image block to be encoded, and obtain the pixel value of each pixel to be encoded in the image frame 12 based on the residual of the prediction block corresponding to each image block to be encoded and the image frame 12. In some embodiments, the image frame 12 and the reference image may have the same size, and the image block to be encoded may have the same size as tis corresponding prediction block.

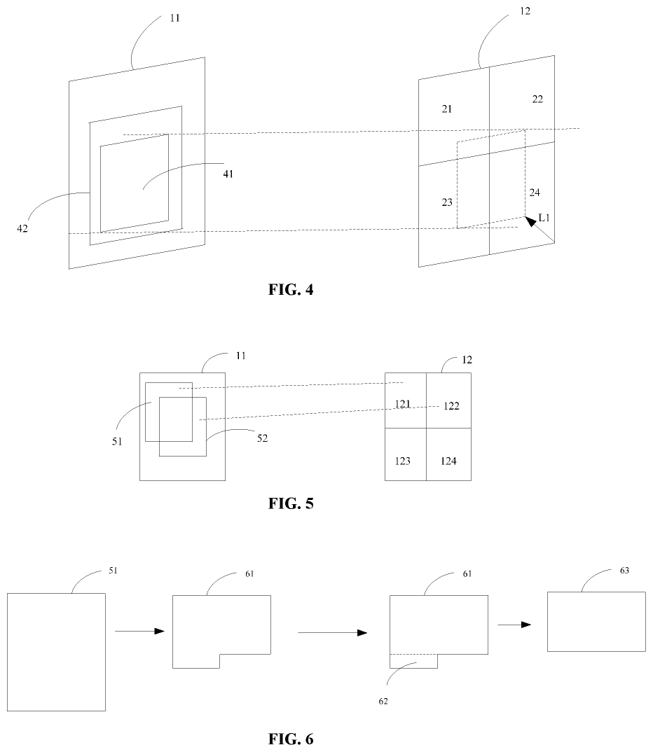

In some embodiments, when searching the image block that best matches the image block to be encoded in the reference image, a search area corresponding to the image block to be encoded in the reference image can be determined first. Next, the image block that best matches the image block to be encoded may be searched in the search area, and the image block can be used as the prediction block. As shown in FIG. 4, assume that image block to be encoded 24 is the current image block to be encoded, image block 21, image block 22, and image block 23 are the encoded image blocks. Based on the respective motion vectors of the encoded image blocks adjacent to the image block to be encoded 24, such as the image block 22 and the image block 23, the motion vector of the image block to be encoded 24, such as L1, can be predicted. It can be understood that the motion vector L1 may be a predicted motion vector, not the real motion vector of the image block to be encoded 24. Based on the motion vector L1, the reference image, such as an area 41 pointed by the motion vector L1 in the image frame 11, can be determined, and a rectangular search area 42 can be drawn around the area 41 based on a predetermined search range. Further, a motion search can be performed in the search area 42 to detect the image block in the search area 42 that best matches the image block to be encoded 24 as the prediction block, and the motion vector of the image block to be encoded 24 relative to the prediction block may be the real motion vector of the image block to be encoded 24. It can be understood that the prediction block may be the area 41 or it may not be the area 41.

For the encoding device, the reference image may be stored in the external memory of the encoding device, such as the double data rate synchronous dynamic random access memory (DDR SDRAM). When the encoder of the encoding device encodes the image block to be encoded, the data in the reference image may need to be read from the external memory to the cache of the encoding device, and the cache may be a static random access memory (SRAM). The encoding device may include an encoder and a cache. In some embodiments, the encoder may be in communication with the cache, and the encoder may be configured to obtain the search image in the search area from the cache, and encode the image block to be encoded based on the search image. In some embodiments, the encoder and the cache may be integrated in one chip. In some cases, the encoder and the cache may be integrated on different chips, and the encoder may be composed of one or more processors.

As shown in FIG. 5, when the encoding device encodes the image block to be encoded 121, the encoding device needs to read the search area corresponding to the image block to be encoded 121, such as the search images in the search area 51, into the cache from the external memory. When the encoding device encodes the image block to be encoded 122, the encoding device needs to read the search area corresponding to the image block to be encoded 122, such as the search images in the search area 52, into the cache from the external memory. It can be understood that the search area 51 and the search area 52 may or may not have an intersection. As shown in FIG. 5, the search area 51 and the search area 52 partially overlap. When the encoding device encodes the image block to be encoded 122, the search images in the overlapping part of the search area 51 and the search area 52 have been stored in the cache. Therefore, the encoding device only needs to read the search images in the search area 52 that are not stored in the cache from the external memory into the cache, thereby improving the data reading efficiency of the encoding device.

Take the image block to be encoded 121 as an example. When the encoding device reads the search images in the search area 51 from the external memory, the data transfer rate between the encoding device and the external memory, that is, the bandwidth, may be limited. As a result, the encoding device may not be able to read all the search images in the search area 51 into the cache, and the search images actually read may be the area 61 shown in FIG. 6, in which a motion search cannot be performed. Therefore, a rectangular area that is as large as possible may need to be selected in the area 61 for the motion search. For example, a part of the area 61, that is, area 62, can be removed to obtain a rectangular area 63 that is as large as possible, and a motion search can be performed in the rectangular area 63 to search for the prediction block that best matches the image block to be encoded 121. It can be understood that the size of the rectangular area 63 may be greater than or equal to the size of the image block to be encoded 121. As shown in FIG. 6, removing the area 62 in the area 61 is equivalent to wasting a part of the bandwidth between the encoding device and the external memory. As a result, bandwidth resource utilization is low and the coding efficiency is reduced. In order to solve this problem, an embodiment of the present disclosure provides an encoding device control method. The method will be described below in conjunction with specific embodiments.

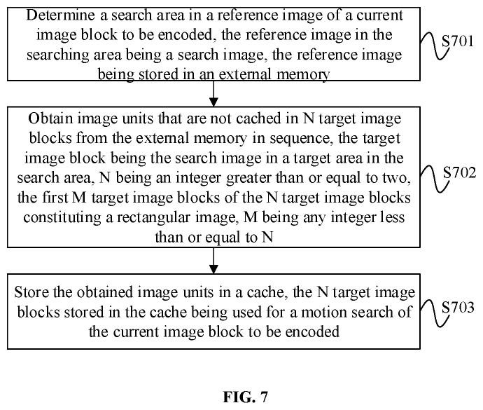

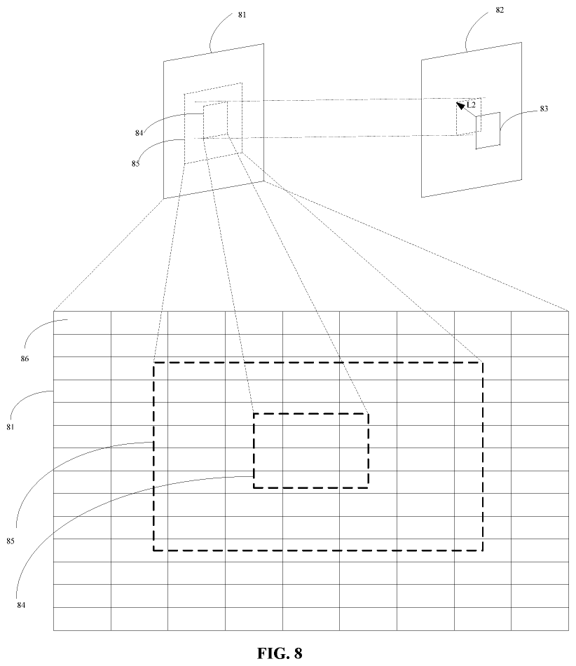

FIG. 7 is a flowchart of an encoding device control method according to an embodiment of the present disclosure. The method will be described in detail below.

S701, determining a search area in the reference image of the current image block to be encoded, the reference image in the search area being a search image, and the reference image being stored in an external memory.

FIG. 8 is a schematic diagram of dividing a search area according to an embodiment of the present disclosure, which includes a reference image 81 and an image to be encoded 82. The image to be encoded 82 includes a plurality of image blocks to be encoded, where an image block to be encoded 83 represents one of the image blocks to be encoded, and the image block to be encoded 83 is the current image block to be encoded. A search area 85 in the reference image 81 is determined to correspond to the image block to be encoded 83.

In some embodiments, determining the search area in the reference image of the current image block to be encoded may include determining the search area in the reference image based on a predicted motion vector of the current image block to be encoded.

More specifically, before determining the search area, the predicted motion vector of the image block to be encoded 83 can be predicted. For example, based on the motion vector of the encoded image block adjacent to the image block to be encoded 83, the motion vector of the image block to be encoded 83 can be predicted, that is, the predicted motion vector of the image block to be encoded 83. A shown in FIG. 8, the predicted motion vector of the image block to be encoded 83 is L2. Further, the corresponding image block 84 pointed by the predicted motion vector L2 can be determined in the reference image 81, and the search area 85 can be determined around the corresponding image block 84. In some embodiments, conventional methods may be adopted to determine the search area 85 based on the corresponding image block 84, which will not be repeated here.

In some embodiments, the reference image in the search area 85 may be a search image, and the reference image 81 may be stored in an external memory in the encoding device. That is, the search image in the search area 85 may be stored in the external memory.

When the encoder in the encoding device encodes the image block to be encoded before the image block to be encoded 83, it may have read part of the image data in the reference image 81 from the external memory into the cache. Therefore, when the search image in the search area 85 is read form the external memory, part of the image data in the search area 85 may already be stored in the cache.

S702, obtaining image units that are not cached in N target image blocks from the external memory in sequence, where the target image block may be the search image in a target area in the search area, N may be an integer greater than or equal to two, the first M target image blocks of the N target image blocks may constitute a rectangular image, and M may be any integer less than or equal to N.

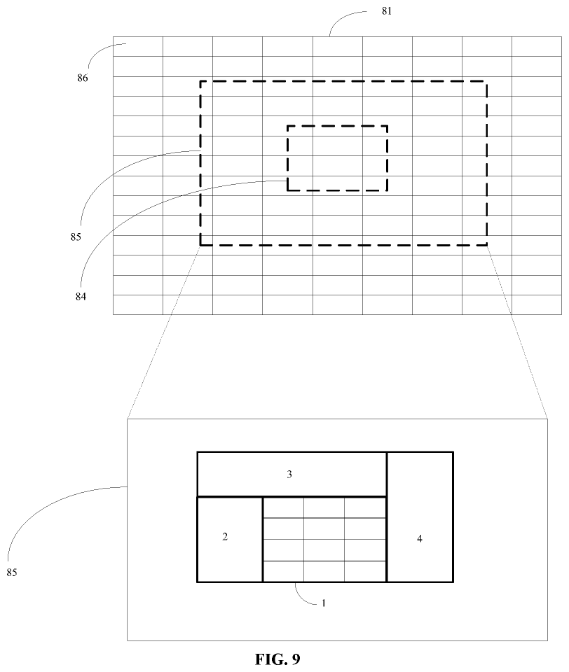

In some embodiments, as shown in FIG. 8, the reference image 81 is divided into a plurality of image units, and image unit 86 represents one of the plurality of image units. As shown in FIG. 9, target areas 1, 2, 3, and 4 are the areas within the search area 85, and the search image in the target area 1 is marked as target image block A, the search image in the target area 2 is marked as target image block B, the search image in the target area 3 is marked as target image block C, and the search image in the target area 4 is marked as target image block D. That is, the search area 85 includes four target image blocks. The description provided here is merely an example, and does not limit the number of target image blocks, nor does it limit the number of image units included in the target image block. For example, multiple consecutive image units in the same row or the same column may be used as a target image block, multiple consecutive image units in multiple consecutive rows or columns may also be used as a target image block.

In some embodiments, the search area 85 may include N target image blocks, where N may be an integer greater than or equal to two. The condition that the N target image blocks needs to meet may be that the first M target image blocks of the N target image blocks constitute a rectangular image, and M may be any integer less than or equal to N. Take N=4 as an example, the first target image block of the four target image blocks, namely a target image block A, constitutes a rectangular image; the first two target image blocks of the four target image blocks, namely the target image block A and a target image block B, constitutes a rectangular image; the first three target image blocks of the four target image blocks, namely the target image block A, the target image block B, and a target image block C, constitutes a rectangular image; and the first four target image blocks of the four target image blocks, namely the target image block A, the target image block B, the target image block C, and a target image block D, constitutes a rectangular image.

In some embodiments, the target area 1, 2, 3, and 4 may respectively include one or more complete image units, as shown in the target area 1. In this embodiment, some of the plurality of image units in the four target areas may have been stored in the cache, and some may not be in the cache. For image units that are not in the cache, these image units may need to be obtained from the external memory in sequence. For example, the image units in the target image block A, the target image block B, the target image block C, and the target image block D that are not cached may be sequentially obtained.

More specifically, the basic component unit of the cache is the cache block, that is, the cache block is the smallest unit of data in the cache. The cache block can be marked as a cache line, and each cache line can store data of the same size. For example, the data size that each cache line can store may be m bytes. Each cache line may also carry address information, and the address information may be used to indicate the position and frame of image data stored in the cache line.

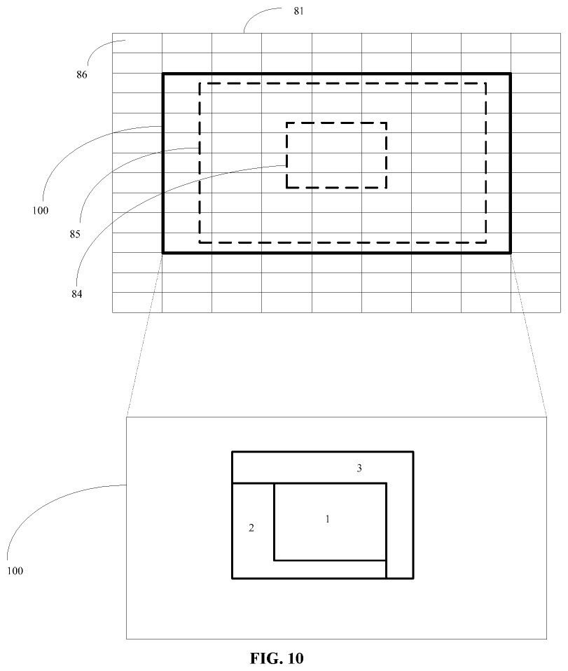

In some embodiments, each image unit may be obtained in a unit of a cache block. That is, the size of the image unit 86 shown in FIG. 8 may be the same as the size of the cache line. The cost of reading a pixel in the search area 85 from the external memory may be the same as the cost of reading the image unit where the pixel is positioned. Therefore, after the original search area corresponding to the image block to be encoded 83 is determined, the original search area may need to be aligned to the boundary of the image unit. As shown in FIG. 10, a search area 100 is the search area after the original search area is aligned to the boundary of the image unit, where the original search area may be determined based on the predicted motion vector of the current image block to be encoded as described above. Further, the target image block in the search area 85 may also be an image block obtained by aligning to the cache line.

In some embodiments, the width of the image unit that the cache line can store may be marked as CacheLineWidth, the height of the cache line may be marked as CacheLineHeight, the upper left corner of the search area 85 may be marked as (UpLeft_x, UpLeft_y), the bottom right corner of the search area 85 may be marked as (RightBottom_x, RightBottom_y), the upper left corner of the search area 85 after aligning the search area 85 to the image unit boundary may be marked as (UL_x, UL_y), and the bottom right corner of the search area 85 may be marked as (RB_x, RB_y). As such:

UL_x=UpLeft_x−UpLeft_x% CacheLineWidth

UL_y=UpLeft_y−UpLeft_y % CacheLineHeight

RB_x=RightBottom_x+CacheLineWidth−1−(RightBottom_x+CacheLineWidth−1)% CacheLineWidth

RB_y=RightBottom_y+CacheLineHeight−1−(RightBottom_y+CacheLineHeight−1)% CacheLineHeight

In some embodiments, one or more of the N target image blocks may not be a rectangular image block. As shown in FIG. 10, the search area 85 includes three target areas, such as target area 1, target area 2, and target area 3. The search image in the target area 1 may be marked as target image block A, the search image in the target area 2 may be marked as target image block B, and the search image in the target area 3 may be marked as target image block C. Since target area 2 and target area 3 are not rectangular areas, the target image block B and the target image block C are not rectangular image blocks. However, target area 1 and target area 2 can form a rectangular area, that is, target image block A and target image block B can form a rectangular image. Further, target area 1, target area 2, and target are 3 can form a rectangular area, that is, target image block A, target image block B, and target image block C can form a rectangular area.

In other embodiments, each of the N target image blocks may be a rectangular image block. As shown in FIG. 9, the search area 85 includes four target image blocks, and each target image block is a rectangular image block.

In some embodiments, the first target image block in the N target image blocks may include at least the corresponding image block pointed to by the predicted motion vector in the search image.

As shown in FIG. 9 or FIG. 10, image block 84 represents the corresponding image block pointed to by the predict motion vector L2, and the search area 85 or the first target image block in the plurality of target image blocks in the search area 85, such as the search image in the target area 1, includes at least the corresponding image block 84. That is, the size of the target area 1 is greater than or equal to the size of the corresponding image block 84.

S703, storing the obtained image units in the cache, where the N target image blocks stored in the cache may be used for motion search of the current image block to be encoded.

Take the target area 1 as an example. When obtaining image units that are not cached in the target image block corresponding to the target area 1 from an external memory, the encoder may send the address information of each image unit in the target area 1 to the cache in sequence, and the cache may compare the address information of the image unit with the address information carried by the cache line. If the address information carried by a cache line in the cache is consistent with the address information of the image unit, it may indicate that the image unit is stored in the cache. The cache may mark the cache line to indicate that the cache line cannot be replaced or stored elsewhere. If the address information carried by each cache line in the cache is inconsistent with the address information of the image unit, it may indicate that the image unit is not cached. At this time, the encoding device may read the image unit from the external memory and store the image unit in the cache.

Similarly, the image units that are not cached in the target area 2, the target area 3, and the target area 4 can be sequentially obtained and stored in the cache, such that the cache can include the target image blocks corresponding to the target area 1, the target area 2, the target area 3, and the target area 4. The target image blocks corresponding to the target area 1, the target area 2, the target area 3, and the target area 4 may respectively constitute a larger area image block, which may be the image data in the rectangular area formed by the target area 1, the target area 2, the target area 3, and the target area 4. The image data in the rectangular area can be used to perform a motion search for the image block to be encoded 83, that is, the image block that best matches the image block to be encoded 83 can be searched and identified from the image data in the rectangular area as the prediction block.

In addition, since the total size of the cache is limited, when the cache has not more space to store new data, the new data may replace the historical data. The embodiments of the present disclosure do not limit the replacement method. In some embodiments, the replacement method may include the most recent use principle, the first-in first-out principle, and the like. The replacement method is equivalent to updating the data stored in the cache, thereby ensuring that the newly read data from the external memory can be stored in the cache.

Consistent with the present disclosure, the image units that are not cached in the N target image blocks can be obtained from the external memory in sequence. The first M target image blocks of the N target image blocks may constitute a rectangular image, and M may be any integer less than or equal to N. In this way, after each image that is not cached in a target image block is obtained and stored in the cache, it can be ensured that the images stored in the cache can all be rectangular images that can be used for motion search, thereby improving bandwidth resource utilization and coding efficiency.

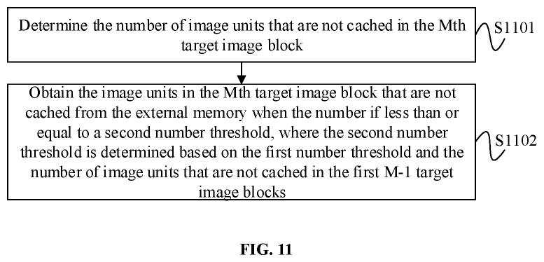

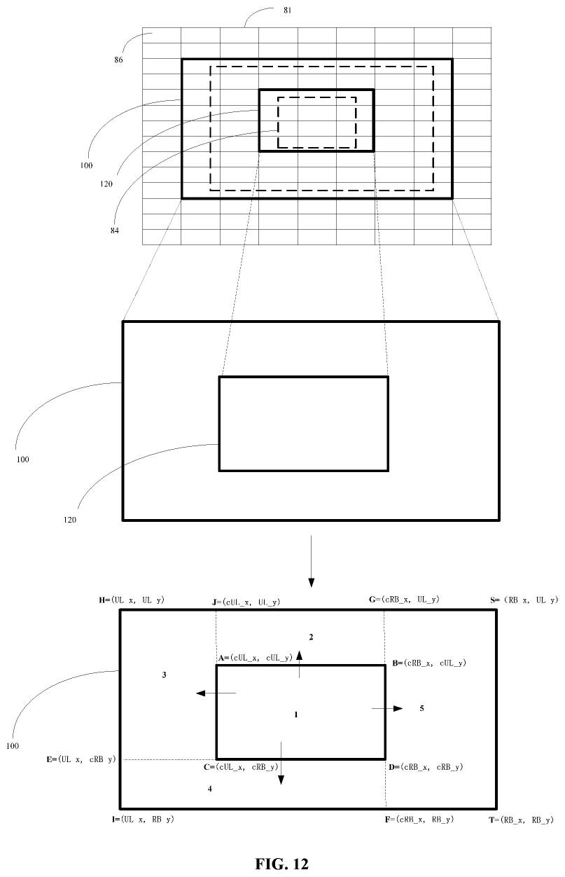

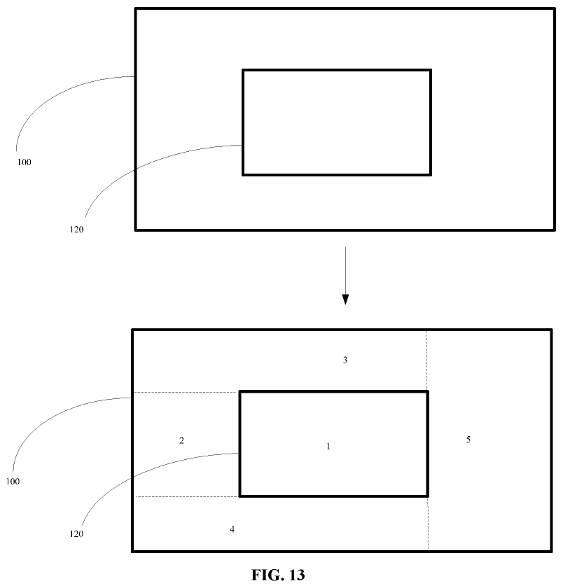

FIG. 11 is a flowchart of the encoding device control method according to another embodiment of the present disclosure. As shown in FIG. 11, based on the above embodiment, N may be the maximum number of target image blocks when the bandwidth limitation condition is met. In some embodiments, meeting the bandwidth limitation condition may include the number of the image units obtained from the external memory being less than or equal to a first number threshold.

Since the bandwidth between the encoding device and the external memory is limited, the number of image units that the encoding device can obtain from the external memory may be limited. In some embodiments, under the condition of bandwidth limitation, the number of image units that the encoding device can obtain from the external memory may be less than or equal to the first number threshold. Since the target image block can be one or more image units, the number of target image blocks that the encoding device can obtain from the external memory may also be limited. For example, under the condition of bandwidth limitation, the number of target image blocks that the encoding device can obtain from the external memory may be less than or equal to N. That is, n may be the maximum number of target image blocks that the encoding device can obtain from the external memory under the condition of meeting the bandwidth limitation. Assume that the maximum target image blocks that the encoding device can obtain from the external memory are the four target image blocks shown in FIG. 9, under the condition of meeting the bandwidth limitation, N=4.

Correspondingly, obtaining the Mth target image block may include the following processes.

S1101, determining the number of image units that are not cached in the Mth target image block.

As shown in FIG. 9, the search area 85 includes four target image blocks. Here, the second target image block, that is, the search image in the target area 2, is taken as an example for the following description. When obtain the second target image block, the number of image units that are not cached in the second target image block may need to be determined first. More specifically, the encoder may send the address information of each image unit included in the second target image block to the cache, and the cache may determine whether each image unit included in the second target image block is stored in the cache based on the address information carried by each cache line and the address information of the image unit, thereby determining the number of image units in the second target image block that are not stored in the cache.

S1102, obtaining the image units in the Mth target image block that are not cached from the external memory when the number if less than or equal to a second number threshold, where the second number threshold may be determined based on the first number threshold and the number of image units that are not cached in the first M−1 target image blocks.

Take M=3 as an example. Due to the bandwidth limitation, the number of image units that the encoding device can obtain from the external memory may be less than or equal to the first number threshold, and the encoding device may sequentially obtain the image units in the first target image block that are not cached, the image units in the second target image block that are not cached, the image units in the third target image block that are not cached, and the image units in the fourth target image block that are not cached. Therefore, when the encoding device obtains the image units that are not cached in the third target image block from the external memory, the second number threshold may need to be determined based on the first number threshold and the number of image units in the first two target image blocks that are not cached (that is, the number of image units that are not cached in the first target image block, that is, the search image in the target area 1, and the number of image units that are not cached in the second target image block, that is, the search image in the target area 2). The second number threshold may be the difference between the first number threshold and the number of image units that are not cached in the first two target image blocks. If the number of image units that are not cached in the third target image block is less than or equal to the second number threshold, the encoding device may obtain the image units that are not cached in the third target image block from the external memory. Otherwise, the encoding device may no longer obtain image units from the external memory. That is, the encoding device may no longer obtain the unit from the external memory, such as not obtaining the image units that are not cached in the fourth target image block, that is, the search image in the target area 4. The encoding device may perform a motion search on the current image block to be encoded based on the first M−1 target image blocks stored in the cache. For example, the encoding device may perform a motion search based on the first two target image blocks (that is, the first target image block, that is, the search image in the target area 1, and the second target image block, that is, the search image in the target area 2).

In some embodiments, the first number threshold may be determined based on a third number threshold and/or a fourth number threshold. In some embodiments, the third number threshold may be a predetermined maximum number of image units that are not cached and stored in the search image corresponding to each image block to be encoded, obtained from the external memory. In some embodiments, the fourth number threshold may be determined based on a fifth predetermined number threshold and the number of image units that are not cached in the search image corresponding to the K−1 image blocks to be encoded before the current image block to be encoded is obtained from the external memory. The current image block to be encoded may be the Kth image block to be encoded in the K image block to be encoded. The fifth predetermined number threshold may be a predetermined maximum number of image units that are not cached and stored in the search images corresponding to the K image block to be encoded, obtained from the external memory, and K may be an integer greater than or equal to two.

Generally, in order to ensure that the peak bandwidth is not too large, the encoding device may be set to obtain a predetermined maximum number of image units that are not cached in the search image corresponding to each image block to be encoded from the external memory. The predetermined maximum number may be marked as Th0. In this embodiment, Th0 is marked as the third number threshold.

As shown in FIG. 8, the image block to be encoded 83 is the Kth image block to be encoded in the image to be encoded 82, and the image block to be encoded 83 is the current image block to be encoded. Since the encoding device consumes bandwidth resources when reading data from the external memory, and the encoding device does not consume bandwidth resource when reading data from the cache, therefore, the data that the encoder needs when encoding the image block to be encoded 83 is the image data that is not cached in the search image corresponding to the image block to be encoded 83, that is, the image data in the search image corresponding to the image block to be encoded 83 that the encoding device needs to request from the external memory. However, the bandwidth between the encoding device and the external memory is limited. Assume that under the bandwidth limitation, the amount of image data in the search image corresponding to the image block to be encoded 83 that the encoding device can read from the external memory cannot exceed M times the size of the image block to be encoded 83, if the size of the image block to be encoded 83 is P pixels, then the image block to be encoded 83 may be equivalent to

$$\frac{P}{CacheLineWidth \times CacheLineHeight}$$

cache lines. The amount of image data in the search image corresponding to the image block to be encoded 83 that the encoding device can read from the external memory may not exceed

$$\frac{M \times P}{CacheLineWidth \times CacheLineHeight}$$

cache lines. That is, the maximum value of the amount of image data in the search image corresponding to the image block to be encoded 83 that the encoding device can read from the external memory may be

$$\frac{M \times P}{CacheLineWidth \times CacheLineHeight}$$

cache lines. In practical applications, a sliding window strategy is generally adopted to ensure that the image data in the search image corresponding to the continuous K image blocks to be encoded that the encoding device can read from the external memory cannot exceed

$$\frac{M \times P \times K}{CacheLineWidth \times CacheLineHeight}$$

cache lines. That is, the maximum value of the amount of image data in the search image corresponding to the continuous K image blocks to be encoded that the encoding device can read from the external memory may be

$$\frac{M \times P \times K}{CacheLineWidth \times CacheLineHeight}$$

cache lines. Here,

$$\frac{M \times P \times K}{CacheLineWidth \times CacheLineHeight}$$

may be marked as the fifth number threshold.

Since when the encoder encodes the K−1 image blocks to be encoded before the image block to be encoded 83, the encoding device may have read part of the image data in the search image corresponding to the K−1 image blocks to be encoded from the external memory. Assume that the size of this part of the image data is marked as NumPreFreched1, and NumPreFreched1 may be the number of image units that are not cached in the search image corresponding to the K−1 image blocks to be encoded before the image block to be encoded 83 obtained by the encoding device from the external memory. If NumPreFreched1 is greater than or equal to

$$\frac{M \times P \times K}{CacheLineWidth \times CacheLineHeight} ,$$

it may indicate that due to the bandwidth limitation between the encoding device and the external memory, the encoding device cannot read the image data in the search image corresponding to the image block to be encoded 83 from the external memory. If NumPreFreched1 is less than

$$\frac{M \times P \times K}{CacheLineWidth \times CacheLineHeight} ,$$

it may indicate that the encoding device can read the image data in the search image corresponding to the image block to be encoded 83 from the external memory. The fourth number threshold can be determined based on the NumPreFreched1 and

$$\frac{M \times P \times K}{CacheLineWidth \times CacheLineHeight} .$$

In some embodiments, the fourth number threshold may be the difference between

$$\frac{M \times P \times K}{CacheLineWidth \times CacheLineHeight}$$

### and NumPreFreched1.

In some embodiments, the first number threshold may be the smaller value of the third number threshold and the fourth number threshold.

That is, under the condition that NumPreFreched1 is less than

$$\frac{M \times P \times K}{CacheLineWidth \times CacheLineHeight} ,$$

the maximum number of image units in the search image corresponding to the image block to be encoded 83 that the encoding device can obtain from the external memory may be

$$min ( \frac{M \times P \times K}{CacheLineWidth \times CacheLineHeight} - NumPreFreched 1 , Th 0 ) .$$

### Here, the

$$min ( \frac{M \times P \times K}{CacheLineWidth \times CacheLineHeight} - NumPreFreched 1 , Th 0 )$$

may be noted as AllowedNum.

In some other embodiments, the same image block to be encoded may corresponding to a plurality of search areas. The plurality of search areas may be in the same frame of image, or not in the same frame of image. Assume that the image block to be encoded 83 corresponds to two search areas, namely a first search area and a second search area. The encoding device may first obtain the image data that is not cached and stored in the first search area from the external memory, and then obtain the image data that is not cached and stored in the second search area from the external memory. If the number of image units that have not been cached in the first search area that the encoding device has obtained from the external memory is NumPreFreched2, when the encoding device obtains image data that is not cached and stored in the second search area, the encoding device may not only need to determine the number of image units that are not cached in the search image corresponding to the K−1 image blocks to be encoded before the image block to be encoded 83 obtained by the encoding device from the external memory, that is, NumPreFreched1, the encoding device may also need to determine the number of image units that have not been cached in the first search area that the encoding device has obtained from the external memory, that is, NumPreFreched2. Assume the sum of NumPreFreched1 and NumPreFreched2 is noted as NumPreFreched, if NumPreFreched is greater than or equal to

$$\frac{M \times P \times K}{CacheLineWidth \times CacheLineHeight} ,$$

it may indicate that due to the bandwidth limitation between the encoding device and the external memory, the encoding device cannot read the image data in the search image corresponding to the image block to be encoded 83 from the external memory. If NumPreFreched is less than

$$\frac{M \times P \times K}{CacheLineWidth \times CacheLineHeight} ,$$

it may indicate that the encoding device can read the image data in the search image corresponding to the image block to be encoded 83 from the external memory, and the maximum number of image units in the search image corresponding to the image block to be encoded 83 that the encoding device can obtain from the external memory may be

$$min ( \frac{M \times P \times K}{CacheLineWidth \times CacheLineHeight} - NumPreFetched 1 , Th 0 ) .$$

### Here,

$$min ( \frac{M \times P \times K}{CacheLineWidth \times CacheLineHeight} - NumPreFetched 1 , Th 0 )$$

may be noted as AllowedNum.

Consistent with the present disclosure, by calculating the maximum number of target image blocks that the encoding device can obtain from the external memory under the bandwidth limitation, the encoding device can obtain the largest rectangular image block from the external memory as much as possible under the bandwidth limitation, thereby improving the resource utilization of the bandwidth.

Based on the foregoing embodiments, the method for reading a plurality of target image blocks in the search area may include the following implementations.

In one implementation, the M−1 target image block may be a rectangular image block that takes a side of a rectangular image block composed of the previous M−2 target image blocks as a side, and is away from the M−2th target image block in a first direction. When the M−1th target image block includes a boundary image of the search image, the Mth target image block may be a rectangular image block that take a side of a rectangular image block composed of the previous M−1 target image blocks as a side, and is away from the M−1th target image block in a second direction. In some embodiments, the second direction may be different from the first direction. When the M−1th target image block does not include the boundary image of the search image, the Mth target image block may be a rectangular image block that takes a side of a rectangular image block composed of the previous M−1 target image blocks as a side, and is away from the M−1th target image block in the first direction.

As shown in FIG. 12, image block 84 is the corresponding image block pointed to by the predicted motion vector L2, and image block 120 is the corresponding image block after the corresponding image block 84 is aligned to the image unit boundary. Search area 100 is the search area after the search area 85 is aligned to the image unit boundary. In this embodiment, the search area 85 is divided into five target image blocks, where the first target image block is the search image in the target area 1, the second target image block is the search image in the target area 2, and so on, and the fifth target image block is the search image in the target area 5. In some embodiments, the first target image block may be the corresponding image block 120 after the corresponding image block 84 is aligned to the image unit boundary. The encoding device may first obtain the image units in the first target image block, and then obtain the image units in the other four target image blocks, and the obtaining order may be in a counterclockwise order.

In other embodiments, the search area 85 may also be divided into five target image blocks as shown in FIG. 13. After obtaining the image units in the first target image block, the encoding device may obtain the image units in the other four target image blocks in the counterclockwise order. It can be understood that the description provided here is an example, and does not limit the specific division method of the search area 85, nor does it limit the acquisition order of the image units in the plurality of target image blocks after the division.

Take the five target image blocks shown in FIG. 12 as an example. The four vertices of the first target image block are point A, point B, point C, and point D. Assume the coordinates of point A are (cUL_x, cUL_y), the coordinates of point B are (cRB_x, cUL_y), the coordinates of point C are (cUL_x, cRB_y), and the coordinates of point D are (cRB_x, cRB_y). The four vertices of the search area 85 are point H, point S, point I, and point T. Assume the coordinates of point H are (UL_x, UL_y), the coordinates of point S are (RB_x, UL_y), the coordinates of point I are (UL_x, RB_y), and the coordinates of point T are (RB_x, RB_y).

The method of reading the image units in the five target image blocks may include the following processes.

In the first process, the encoder may send the address information of all image units in the area ABCD to the cache, and the cache may compare the address information carried by each cache line with the address information of the image unit. If the address information carried by a cache line in the cache is consistent with the address information of the image unit, it may indicate that the image unit is stored in the cache. If the address information carried by each cache line is inconsistent with the address information of the image unit, it may indicate that the image unit is not in the cache and need to be read form the external memory to determine how many image units in the area ABCD need to be read from the external memory, and the number of image units that need to be read from the external memory in the area ABCD may be noted as Num1. Num1 can be compared with AllowedNum. If Num1 is greater than AllowedNum, it may indicate that the first target image block cannot be obtained under the bandwidth limitation, and the search area 85 can be marked as unavailable. The reading and searching of the search image in the search area 85 can be directly abandoned, and the sixth process can be performed. If Num1 is less than or equal to AllowedNum, it may indicate that all image units in the area ABCD can be successfully read under the bandwidth limitation, and the search area 85 can be marked as available. The available areas may be (cUL_x, cUL_y) to (cRB_x, cRB_y), and the encoding device may send a data read request to the external memory to read from the external memory the image units in the area ABCD that are not cached. At the end, Num1 may be subtracted from the value of AllowNum to obtain an updated AllowNum, and the process may proceed to the second process.

In the second process, as shown in FIG. 12, the four vertices of the second target image block are point J, point G, point A, and point B. The coordinates of point J are (cUL_x, UL_y), the coordinates of point G are (cRB_x, UL_y), the coordinates of point A are (cUL_x, cUL_y), and coordinates of point B are (cRB_x, cUL_y). The second target image block is a rectangular image block that takes a side of the rectangular image block formed by the first target image block, such as side AB, as a side, and is away from the first target image block in a first direction, such as from bottom to top. The method of reading the second target image block may be reading row by row from left to right, and from bottom to top. That is, start from the image unit in the bottom row of the area JGAB and follow the order from bottom to top, and send the request for obtaining the image unit to the cache row by row. For example, send a request to the cache to obtain each image unit in the bottom row of the area JGAB, and record the coordinates of the upper left corner of the first image unit in the row from left to right as (cUL_x, y2). In some embodiments, point H may be taken as the origin of the coordinate, the horizontal right direction passing the point H may be the X axis of the coordinate, and the vertical downward direction passing the point H may be the Y axis of the coordinate, then y2=cUL_y−CacheLineHeight. CacheLineHeight may represent the height of a cache line, and also the height of an image unit. In some embodiments, the request may include the address information of each image unit in the bottom row of the area JGAB. The cache may determine the number of image units in the row of image units that need to be read from the external memory based on the address information of each image unit in the bottom row of the area JGAB, and this number may be noted as Num2. Num2 can be compared with the updated AllowNum. If Num2 is greater than the updated AllowNum, it may indicate that the image unit of the row cannot be obtained under the bandwidth limitation. The search area 85 can be marked as available, the available area may be from (cUL_x,y2+CacheLineHeight) to (cRB_x, cRB_y), and the sixth process can be performed. If Num2 is less than or equal to the updated AllowNum, it may indicate that the image unit in the bottom row of the area JGAB can be successfully read under the bandwidth limitation. The cache may send a data read request to the external memory to read the Num2 image units that are not stored in the cache from the external memory, and subtract Num2 from the value of AllowNum to obtain the updated AllowNum. Similarly, the image units of each row in the area JGAB can be read in the order from bottom to top until all the image units in the area JGAB that are not cached are read from the external memory, or until AllowNum is less than the number of image units that are not cached in the current row. If all the image units in the area JGAB that are not cached can be read from the external memory, the process may proceed to the third process. If AllowNum is less than the number of image units that are not cached in the current row, the sixth process may be performed.

In the third process, as shown in FIG. 12, the four vertices of the third target image block are point H, point J, point E, and point C, and the coordinates of point H are (UL_x, UL_y), the coordinates of point J are (cUL_x, UL_y), the coordinates of point E are (UL_x, cRB_y), and the coordinates of point C are (cUL_x, cRB_y). The third target image block is a rectangular image block that takes a side of the rectangular image block formed by the first target image block and the second target image block, such as side JC, as a side, and is away from the second target image block in a second direction, such as from right to left. The method of reading the third target image block may be reading column by column from top to bottom, and from right to left. That is, start from the image unit in the rightmost column of the area HJEC and follow the order from right to left, and send the request for obtaining the image unit to the cache column by column. For example, send a request to the cache to obtain each image unit in the rightmost column of the area HJEC, and record the coordinates of the upper left corner of the first image unit in the column from top to bottom as (x3, UL_y). In some embodiments, x3=cUL_x−CacheLineWidth. CacheLineWidth may represent the width of a cache line, and also the width of an image unit. The cache may determine the number of image units in the column of image units that need to be read from the external memory, and this number may be noted as Num3. Num3 can be compared with the updated AllowNum. If Num3 is greater than the updated AllowNum, it may indicate that the image unit of the column cannot be obtained under the bandwidth limitation. The search area 85 can be marked as available, the available area may be from (x3+CacheLineWidth,UL_y) to (cRB_x, cRB_y), and the sixth process can be performed. If Num3 is less than or equal to the updated AllowNum, it may indicate that each image unit in the rightmost column of the area HJEC can be successfully read under the bandwidth limitation. The cache may send a data read request to the external memory to read the Num3 image units that are not stored in the cache from the external memory, and subtract Num3 from the value of AllowNum to obtain the updated AllowNum. Similarly, the image units of each column in the area HJEC can be read in the order from right to left until all the image units in the area HJEC that are not cached are read from the external memory, or until AllowNum is less than the number of image units that are not cached in the current column. If all the image units in the area HJEC that are not cached can be read from the external memory, the process may proceed to the fourth process. If AllowNum is less than the number of image units that are not cached in the current column, the sixth process may be performed.

In the fourth process, as shown in FIG. 12, the four vertices of the fourth target image block are point E, point D, point I, and point F, and the coordinates of point E are (UL_x, cRB_y), the coordinates of point D are (cRB_x, cRB_y), the coordinates of point I are (UL_x, RB_y), and the coordinates of point F are (cRB_x, RB_y). The fourth target image block is a rectangular image block that takes a side of the rectangular image block formed by the first target image block, the second target image block, and the third target image block, such as side ED, as a side, and is away from the third target image block in a third direction, such as from top to bottom. The method of reading the fourth target image block may be reading row by row from left to right, and from top to bottom. That is, start from the image unit in the top row of the area EDIF and follow the order from top to bottom, and send the request for obtaining the image unit to the cache row by row. For example, send a request to the cache to obtain each image unit in the top row of the area EDIF, and record the coordinates of the upper left corner of the first image unit in the row from left to right as (UL_x, y4), where y3=cRB_y. The cache may determine the number of image units in the row of image units that need to be read from the external memory, and this number may be noted as Num4. Num4 can be compared with the updated AllowNum. If Num4 is greater than the updated AllowNum, it may indicate that the image unit of the row cannot be obtained under the bandwidth limitation. The search area 85 can be marked as available, the available area may be from (UL_x, UL_y) to (cRB_x, y4), and the sixth process can be performed. If Num4 is less than or equal to the updated AllowNum, it may indicate that each image unit in the top row of the area EDIF can be successfully read under the bandwidth limitation. The cache may send a data read request to the external memory to read the Num4 image units that are not stored in the cache from the external memory, and subtract Num4 from the value of AllowNum to obtain the updated AllowNum. Similarly, the image units of each row in the area EDIF can be read in the order from top to bottom until all the image units in the area EDIF that are not cached are read from the external memory, or until AllowNum is less than the number of image units that are not cached in the current row. If all the image units in the area EDIF that are not cached can be read from the external memory, the process may proceed to the fifth process. If AllowNum is less than the number of image units that are not cached in the current row, the sixth process may be performed.

In the fifth process, as shown in FIG. 12, the four vertices of the fifth target image block are point G, point S, point F, and point T, and the coordinates of point G are (cRB_x, UL_y), the coordinates of point S are (RB_x, UL_y), the coordinates of point F are (cRB_x, RB_y), and the coordinates of point T are (RB_x, RB_y). The fifth target image block is a rectangular image block that takes a side of the rectangular image block formed by the first target image block, the second target image block, the third target image block, and the fourth target image block, such as side GF, as a side, and is away from the fourth target image block in a fourth direction, such as from left to right. The method of reading the fifth target image block may be reading column by column from top to bottom, and from left to right. That is, start from the image unit in the leftmost column of the area GSFT and follow the order from left to right, and send the request for obtaining the image unit to the cache column by column. For example, send a request to the cache to obtain each image unit in the leftmost column of the area GSFT, and record the coordinates of the upper left corner of the first image unit in the column from top to bottom as (x5, UL_y), where x3=cRB_x. The cache may determine the number of image units in the column of image units that need to be read from the external memory, and this number may be noted as Num5. Num5 can be compared with the updated AllowNum. If Num5 is greater than the updated AllowNum, it may indicate that the image unit of the column cannot be obtained under the bandwidth limitation. The search area 85 can be marked as available, the available area may be from (UL_x, UL_y) to (x5, RB_y), and the sixth process can be performed. If Num5 is less than or equal to the updated AllowNum, it may indicate that each image unit in the leftmost column of the area GSFT can be successfully read under the bandwidth limitation. The cache may send a data read request to the external memory to read the Num5 image units that are not stored in the cache from the external memory, and subtract Num5 from the value of AllowNum to obtain the updated AllowNum. Similarly, the image units of each column in the area GSFT can be read in the order from left to right until all the image units in the area GSFT that are not cached are read from the external memory, or until AllowNum is less than the number of image units that are not cached in the current column. If all the image units in the area GSFT that are not cached can be read from the external memory, the search area 85 can be marked as available, and the available area may be from (UL_x, UL_y) to (cRB_x, cRB_y).

In the sixth process, if the search area 85 is unavailable, motion search may no longer be performed on the search area 85. If the search area 85 is available, a motion search may be performed within the available area in the search area 85. It can be understood that the first target image block, that is, the search image in the area ABCD, may be the corresponding image block after aligning the corresponding image block 84 to the boundary of the image unit. The corresponding image block 84 may represent the corresponding image block pointed to by the predicted motion vector L2, and the size of the corresponding image block 84 may be the same as the size of the image block to be encoded 83. Therefore, when the available area in the search area 85 includes at least the first target image block, the motion search for the image block to be encoded 83 may be performed to search for the image block that best matches the image block to be encoded 83 from the available area.

In some embodiments, as shown in FIG. 12, each row of image units in the target area 2, that is, the area JGAB, can be considered as a target image block; each column of image units in the target area 3, that is, the area HJEC, can be considered as a target image block; each row of image units in the target area 4, that is, the area EDIF, can be considered as a target image block; and each column of image units in the target area 5, that is, the area GSFT, can also be considered as a target image block.

For example, the image units in the bottom row of the area JGAB may constitute a target image block. When reading the image units of each row in the area JGAB sequentially, the target image block formed by the image units of the current row may be marked as the M−1th target image block. If the current row does not include the boundary image of the search image, such as the boundary JG, the process may continue to obtain the image units of the Mth target image block (i.e., the previous row of the M−1th target image block) along the first direction (i.e., from bottom to top). That is, the Mth target image block may be a rectangular image block that takes the a side of rectangular image block formed by the previous M−1 target image blocks, such as the top side of the rectangular image block formed by the M−1 target image block as a side, and is away from the M−1th target image block in the first direction, that is, from bottom to top.

If the current row includes the boundary image of the search image, such as boundary JG, it may indicate that the current row is already the top row of the area JGAB, and the rectangular image block formed by the previous M−1 target image blocks may correspond to the area JGCD. Based on the principle of reading the target image block near the read area, the next target image block that needs to be obtained, that is, the Mth target image block may be a target image block formed by the image units on the right most row of the area HJEC. It can be seen that the Mth target image block may be a rectangular image block that takes a side of a rectangular image block formed by the previous M−1 target image blocks, such as side JC, as a side, and is away from the M−1 target image block in the second direction, such as from right to left.

In another implementation, the M−1th target image block may be a rectangular image block that takes a side of the rectangular image block formed by the previous M−2 target image blocks as a side, and is away from the M−2th target image block in the first direction. The Mth target image block may be a rectangular image block that takes a side of the rectangular image block formed by the previous M−1 target image blocks as a side, and is away from the M−2th target image block in the second direction. In some embodiments, the second direction may be different from the first direction.

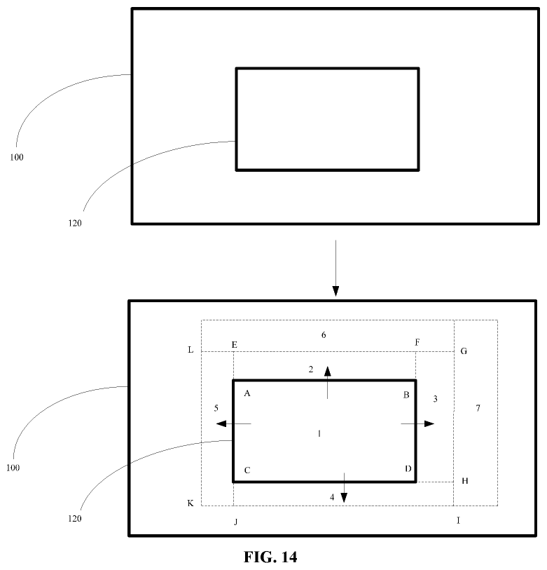

When reading the search image in the search area 85, the reading order of the target image blocks may be as shown in FIG. 14. For example, the first target image block may be the search image in the target area 1. After successfully reading the search image in the target area 1, the search image in the second target image block, that is, the target area 2, can be read by taking a side of the target area 1, such as side AB, and moving away from the first target image block in the first direction, such as from bottom to top.

After successfully reading the search image in the target area 2, the search image in the third target image block, that is, the target area 3, can be read by taking a side of the rectangular area EFCD formed by the target area 1 and the target area 2, such as side FD, and moving away from the second target image block in the second direction, such as from left to right.

After successfully reading the search image in the target area 3, the search image in the fourth target image block, that is, the target area 4, can be read by taking a side of the rectangular area EGCH formed by the target area 1, the target area 2, and the target area 3, such as side CH, and moving away from the third target image block in the third direction, such as from top to bottom.

After successfully reading the search image in the target area 4, the search image in the fifth target image block, that is, the target area 5, can be read by taking a side of the rectangular area EGJI formed by the target area 1, the target area 2, the target area 3, and the target area 4, such as side EJ, and moving away from the fourth target image block in the fourth direction, such as from right to left.

Similarly, after successfully reading the search image in the target area 5, the search image in the target area 6 may be read based on the method of reading the first target image block. After successfully reading the search image in the target area 6, the search image in the target area 7 may be read based on the method of reading the second target image block, until all search images in the search area 85 are read. Alternatively, under the bandwidth limitation, the search image read from the search area 85 may be a rectangular image block smaller than the search area 85 and larger than the first target image block.

In another implementation, the Mth target image block may be a rectangular image block that takes a side of the rectangular image block formed by the previous M−1 target image blocks as a side, and is away from the M−2th target image block in the second direction. In some embodiments, the length of the side adjacent to the side in the Mth target image block may be the width or height of the image unit that can be stored in a cache block.

As shown in FIG. 14, the second target image block, that is, the search image in the target area 2, can be a row of consecutive image units, and the target area 2 is a rectangular image block with one side of the target area 1, such as side AB, as a side, and away from the first target image block in the first direction. The side AE or BF adjacent to side AB in the target area 2 may be the height of the image unit that the cache block can store. The third target image block, that is, the search image in the target area 3, can be a column of consecutive image units, and the target area 3 is a rectangular image block that has one side of the rectangular area formed by the target area 1 and the target area 2, such as side FD, as a side, and is away from the second target image block in the second direction. The side FG or DH adjacent to side FD in the target area 3 may be the width of the image unit that the cache block can store.

Consistent with the present disclosure, by first obtaining the image unit in the corresponding image block pointed to by the predicted motion vector of the image block to be encoded in the search area, the corresponding image block can be ensured to be in the available area in the search area, such that the available are can be used to perform motion search on the image block to be encoded. Further, based on the principle of reading the target image block close to the read area, the rectangular image blocks adjacent to the available area can be obtained in sequence, such that the available area can remain a rectangular area. In this way, the available area can be continuously obtained while meeting the bandwidth limitation, such that the area of the available area can be maximized, and the resource utilization of bandwidth can be improved.

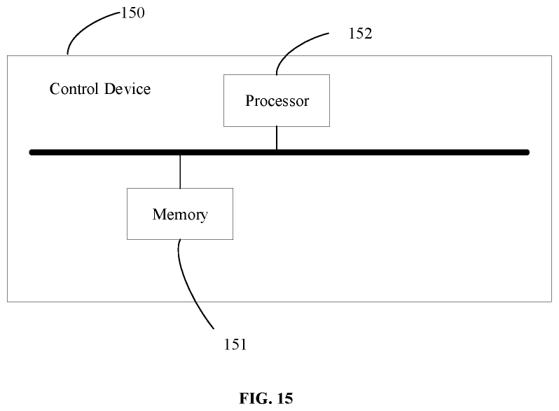

An embodiment of the present disclosure further provides an encoding device control device. FIG. 15 is a structural schematic diagram of an encoding device control device according to an embodiment of the present disclosure. As shown in FIG. 15, an encoding device control device 150 includes a memory 151 and a processor 152. The memory 151 can be configured to store program instructions. The processor 152 can be configured to execute the program instructions stored in the memory 151. When executed by the processor 152, the program instructions can cause the processor 152 to determine a search area in the reference image of the current image block to be encoded, the reference image in the search area being a search image, and the reference image being stored in an external memory; obtain image units that are not cached in N target image blocks from the external memory in sequence, where the target image block may be the search image in a target area in the search area, N may be an integer greater than or equal to two, the first M target image blocks of the N target image blocks may constitute a rectangular image, and M may be any integer less than or equal to N; and store the obtained image units in the cache, where the N target image blocks stored in the cache may be used for motion search of the current image block to be encoded.

In some embodiments, each image unit may be obtained in a cache block.

In some embodiments, N may be the maximum number of target image blocks when the bandwidth limitation condition is met. In some embodiments, meeting the bandwidth limitation condition may include the number of the image units obtained from the external memory being less than or equal to a first number threshold.

In some embodiments, when obtaining the Mth target image block, the processor 152 may be configured to determine the number of image units that are not cached in the Mth target image block; and obtain the image units in the Mth target image block that are not cached from the external memory when the number if less than or equal to a second number threshold, where the second number threshold may be determined based on the first number threshold and the number of image units that are not cached in the first M−1 target image blocks.

In some embodiments, the first number threshold may be determined based on a third number threshold and/or a fourth number threshold. In some embodiments, the third number threshold may be a predetermined maximum number of image units that are not cached and stored in the search image corresponding to each image block to be encoded, obtained from the external memory. In some embodiments, the fourth number threshold may be determined based on a fifth predetermined number threshold and the number of image units that are not cached in the search image corresponding to the K−1 image blocks to be encoded before the current image block to be encoded is obtained from the external memory. The current image block to be encoded may be the Kth image block to be encoded in the K image block to be encoded. The fifth predetermined number threshold may be a predetermined maximum number of image units that are not cached and stored in the search images corresponding to the K image block to be encoded, obtained from the external memory, and K may be an integer greater than or equal to two.

In some embodiments, the first number threshold may be the smaller value of the third number threshold and the fourth number threshold.

In some embodiments, one or more of the N target image blocks may not be a rectangular image block.

In some embodiments, each of the N target image blocks may be a rectangular image block.

In one implementation, the M−1 target image block may be a rectangular image block that takes a side of a rectangular image block composed of the previous M−2 target image blocks as a side, and is away from the M−2th target image block in a first direction. When the M−1th target image block includes a boundary image of the search image, the Mth target image block may be a rectangular image block that take a side of a rectangular image block composed of the previous M−1 target image blocks as a side, and is away from the M−1th target image block in a second direction. In some embodiments, the second direction may be different from the first direction. When the M−1th target image block does not include the boundary image of the search image, the Mth target image block may be a rectangular image block that takes a side of a rectangular image block composed of the previous M−1 target image blocks as a side, and is away from the M−1th target image block in the first direction.

In some embodiments, the M−1th target image block may be a rectangular image block that takes a side of the rectangular image block formed by the previous M−2 target image blocks as a side, and is away from the M−2th target image block in the first direction. The Mth target image block may be a rectangular image block that takes a side of the rectangular image block formed by the previous M−1 target image blocks as a side, and is away from the M−2th target image block in the second direction. In some embodiments, the second direction may be different from the first direction.

In some embodiments, the Mth target image block may be a rectangular image block that takes a side of the rectangular image block formed by the previous M−1 target image blocks as a side, and is away from the M−2th target image block in the second direction. In some embodiments, the length of the side adjacent to the side in the Mth target image block may be the width or height of the image unit that can be stored in a cache block.

In some embodiments, when determining the search area in the reference image of the current image block to be encoded, the processor 152 may be configured to determine the search area in the reference image based on a predicted motion vector of the current image block to be encoded. In some embodiments, the first target image block in the N target image blocks may include at least the corresponding image block pointed to by the predicted motion vector in the search image.

The specific principles and implementation manners of the control device provided by the embodiments of the present disclosure are similar to those of the embodiment shown in FIG. 1, which will not be repeated here.

Consistent with the present disclosure, by determining the search area corresponding to the current image block to be encoded in the reference image, N target image blocks can be determined in the search area, such that the N target image blocks can constitute a rectangular image. The first N−1 target image blocks of the N target image blocks can constitute a rectangular image, the first N−2 target image blocks of the N target image blocks can constitute a rectangular image, and so on, until the previous target image block of the N target image blocks constitutes a rectangular image. Further, the image units that are not cached in the N target image blocks can be obtained from the external memory in sequence. Under the bandwidth limitation of the encoding device and the external memory, the encoding device can consistently obtain a rectangular image in the search area, which solves the problem that the image in the search area obtained by the encoding device is not a rectangular image when the bandwidth between the encoding device and the external memory is exhausted, such that the image needs to be cropped due to the need of perform a motion search, which results in low bandwidth resource utilization.

In addition, an embodiment of the present disclosure further provides a computer-readable storage medium. The computer-readable storage medium can store a computer program. When executed by a processor, the computer program can cause the processor to implement the encoding device control method described in the foregoing embodiments.

In the several embodiments provided by the present disclosure, it should be understood that the disclosed apparatus and method may be implemented in other manners. For example, the apparatus embodiments described above are merely illustrative. For example, the unit division is merely logical function division and there may be other division in actual implementation. For example, multiple units or components may be combined or integrated into another system, or some features can be omitted or not be executed. In addition, the mutual coupling or the direct coupling or the communication connection as shown or discussed may be indirect coupling or communication connection through some interfaces, devices or units, and may be in electrical, mechanical or other forms.

The units described as separate components may or may not be physically separated. The components displayed as units may or may not be physical units, that is, may be located in one place or may also be distributed to multiple network units. Some or all of the units may be selected according to actual needs to achieve the objectives of the solution in the disclosure.

In addition, each functional unit in each embodiment of the present disclosure may be integrated into one processing unit, or each unit may exist alone physically, or two or more units may be integrated in one unit. The above-mentioned integrated unit can be implemented in the form of hardware or in the form of hardware plus software functional unit.

The above-described integrated unit implemented in the form of a software functional unit may be stored in a computer-readable storage medium. The software function unit is stored in a storage medium and includes several instructions for enabling a computer device (which may be a personal computer, a server, a network device, etc.) or a processor to execute some steps of the method according to each embodiment of the present disclosure. The foregoing storage medium includes a medium capable of storing program code, such as a USB flash disk, a removable hard disk, a read-only memory (ROM), a random access memory (RAM), a magnetic disk, an optical disc, or the like.

Those skilled in the art may clearly understand that, for convenience and brevity of description, the division of the foregoing functional modules is only used as an example. In practical applications, however, the above function allocation may be performed by different functional modules according to actual needs. That is, the internal structure of the device is divided into different functional modules to accomplish all or part of the functions described above. For the working process of the foregoing apparatus, reference may be made to the corresponding process in the foregoing method embodiments, and details are not described herein again.

It should be noted that the foregoing embodiments are merely intended for describing the technical solutions of the present disclosure instead of limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A method for controlling an encoding device, comprising:
determining a search area in a reference image of a current image block to be encoded, the reference image in the searching area being a search image, the reference image being stored in an external memory;
obtaining image units that are not cached in N target image blocks from the external memory in sequence, the target image block being the search image in a target area in the search area, N being an integer greater than or equal to two, the first M target image blocks of the N target image blocks constituting a rectangular image, M being any integer less than or equal to N; and
storing the obtained image units in a cache, the N target image blocks stored in the cache being used for a motion search of the current image block to be encoded.

2. The method of claim 1, wherein:
each image unit is obtained in a cache block.

3. The method of claim 2, wherein;
N is a maximum number of target image blocks when a bandwidth limitation condition is met, meeting the bandwidth limitation condition including a number of image units obtained from the external memory being less than or equal to a first number threshold.

4. The method of claim 3, wherein obtaining a Mth target image block includes:
determining the number of image units that are not cached in the Mth target image block; and
obtaining the image units in the Mth target image block that are not cached from the external memory when the number is less than or equal to a second number threshold, the second number threshold being determined based on the first number threshold and the number of image units that are not cached in the first M−1 target image blocks.

5. The method of claim 3, wherein:
the first number threshold is determined based on a third number threshold and/or a fourth number threshold,
the third number threshold being a predetermined maximum number of image units that are not cached and stored in the search image corresponding to each image block to be encoded obtained from the external memory,
the fourth number threshold being determined based on a fifth predetermined number threshold and the number of image units that are not cached and stored in the search image corresponding to a K−1 image block to be encoded before the current image block to be encoded is obtained from the external memory,
the current image block to be encoded being a Kth image block to be encoded in K image blocks to be encoded,
the fifth predetermined number threshold being a predetermined maximum number of image units that are not cached and stored in the search images corresponding to the K image blocks to be encoded obtained from the external memory,
K being an integer greater than or equal to two.

6. The method of claim 5, wherein:
the first number threshold is a smaller number of the third number threshold and the fourth number threshold.

7. The method of claim 1, wherein:
one or more of the N target image blocks are not rectangular image blocks.

8. The method of claim 1, wherein:
each of the N target image blocks is a rectangular image block.

9. The method of claim 8, wherein:
the M−1th target image block is a rectangular image block with one side of a rectangular block formed by the previous M−2 target image blocks as a side and away from the M−2th target image block in a first direction;
when the M−1th target image block includes a boundary image of the search image, the Mth target image block is a rectangular image block with one side of a rectangular image blocked formed by the previous M−1 target image blocks as a side and away from the M−1th target image block in a second direction, the second direction being different from the first direction; and
when the M−1th target image block does not include the boundary image of the search image, the Mth target image block is the rectangular image block with one side of the rectangular image block formed by the previous M−1 target image blocks as a side and away from the M−1th target image block in the first direction.

10. The method of claim 8, wherein:
the M−1th target image block is a rectangular image block with one side of a rectangular image block formed by the previous M−2 target image blocks as a side and away from the M−2th target image block in a first direction;
the Mth target image block is a rectangular image block with one side of a rectangular image block formed by the previous M−1 target image blocks as a side and away from the M−2th target image block in a second direction, the second direction being different from the first direction.

11. The method of claim 8, wherein:
the Mth target image block is a rectangular image block with one side of a rectangular image block formed by the previous M−1 target image blocks as a side and away formed the M−2th target image block in a second direction, a length of the side adjacent to the side in the Mth target image block being a width or a height of the image unit capable of being stored in the cache block.

12. The method of claim 1, wherein determining the search are in the reference image of the current image block to be encoded includes:
determining the search area in the reference image based on a predicted motion vector of the current image block to be encoded, a first target image block in the N target image blocks including at least a corresponding image block pointed to by the predicted motion vector in the search image.

13. A device for controlling an encoding device, comprising:
a processor; and
a memory storing computer instructions that, when executed by the processor, cause the processor to:
determine a search area in a reference image of a current n image block to be encoded, the reference image in the searching area being a search image, the reference image being stored in an external memory;
obtain image units that are not cached in N target image blocks from the external memory in sequence, the target image block being the search image in a target area in the search area, N being an integer greater than or equal to two, the first M target image blocks of the N target image blocks constituting a rectangular image, M being any integer less than or equal to N; and
store the obtained image units in a cache, the N target image blocks stored in the cache being used for a motion search of the current image block to be encoded.

14. The device of claim 13, wherein:
each image unit is obtained in a cache block.

15. The device of claim 14, wherein:
N is a maximum number of target image blocks when a bandwidth limitation condition is met, meeting the bandwidth limitation condition including a number of image units obtained from the external memory being less than or equal to a first number threshold.

16. The device of claim 15, wherein when obtaining the Mth target image block, the instructions further cause the processor to:
determine the number of image units that are not cached in the Mth target image block; and
obtain the image units in the Mth target image block that are not cached from the external memory when the number is less than or equal to a second number threshold, the second number threshold being determined based on the first number threshold and the number of image units that are not cached in the first M−1 target image blocks.

17. The device of claim 13, wherein:
the first number threshold is determined based on a third number threshold and/or a fourth number threshold,
the third number threshold being a predetermined maximum number of image units that are not cached and stored in the search image corresponding to each image block to be encoded obtained from the external memory,
the fourth number threshold being determined based on a fifth predetermined number threshold and the number of image units that are not cached and stored in the search image corresponding to a K−1 image block to be encoded before the current image block to be encoded is obtained from the external memory,
the current image block to be encoded being a Kth image block to be encoded in K image blocks to be encoded,
the fifth predetermined number threshold being a predetermined maximum number of image units that are not cached and stored in the search images corresponding to the K image blocks to be encoded obtained from the external memory,
K being an integer greater than or equal to two.

18. The device of claim 13, wherein:
each of the N target image blocks is a rectangular image block.

19. The device of claim 18, wherein:
the M−1th target image block is a rectangular image block with one side of a rectangular block formed by the previous M−2 target image blocks as a side and away from the M−2th target image block in a first direction;
when the M−1th target image block includes a boundary image of the search image, the Mth target image block is a rectangular image block with one side of a rectangular image blocked formed by the previous M−1 target image blocks as a side and away from the M−1th target image block in a second direction, the second direction being different from the first direction; and
when the M−1th target image block does not include the boundary image of the search image, the Mth target image block is the rectangular image block with one side of the rectangular image block formed by the previous M−1 target image blocks as a side and away from the M−1th target image block in the first direction.

20. The device of claim 13, wherein determining the search are in the reference image of the current image block to be encoded, the instructions further cause the processor to:
determine the search area in the reference image based on a predicted motion vector of the current image block to be encoded, a first target image block in the N target image blocks including at least a corresponding image block pointed to by the predicted motion vector in the search image.
